(19) United States
(12) Patent Application Publication
(10) Pub. No.: US 2004/0078175 A1
(43) Pub. Date: Apr. 22, 2004

(54) Method and apparatus for modeling and simulating the effects of bridge defects in integrated circuits

(75) Inventors: Donald Shaw, Burlington (CA); Dhamin Al-Khalili, Kingston (CA); Come Rozon, Amherstview (CA)

Correspondence Address: OBLON, SPIVAK, MCCLELLAND, MAIER & NEUSTADT, P.C., 1940 DUKE STREET, ALEXANDRIA, VA, 22314, US

(73) Assignee: QUEEN IN RIGHT OF CANADA AS REP BY MIN OF NAT DEF, Ottawa (CA)

(21) Appl. No.: 10/226,147

(22) Filed: Aug. 23, 2002

Related U.S. Application Data
(60) Provisional application No. 60/348,339, filed on Oct. 29, 2001.

(51) Int. Cl. G06F 17/50

(52) U.S. Cl. 703/14; 714/100

(57) ABSTRACT

A bridge fault modeling and simulation apparatus including a neural network simulates the effects of bridge defects in complementary metal oxide semiconductor integrated circuits. The apparatus includes a multilayer feedforward neural network (MLFN), implemented within the framework of a very high speed integrated circuit hardware description language (VHDL) saboteur. The saboteur is placed between logic cells in the IC simulation. The apparatus computes exact bridged node voltages and propagation delay times with due attention to surrounding circuit elements. It results in faster simulation and achieves excellent accuracy.

### CROSS-REFERENCE TO RELATED APPLICATION

Benefit and priority is claimed from United States provisional patent application Serial No. 60/348,339 filed Oct. 29, 2001, which is currently pending and is hereby incorporated by reference into this application.

### TECHNICAL FIELD

The present invention relates to modeling and simulation of bridge defects in integrated circuits with emphasis on complementary metal oxide semiconductor integrated circuits.

### BACKGROUND INFORMATION

Bridge defects account for most of the defects in complementary metal oxide semiconductor (CMOS) integrated circuits (ICs). Considering that a high percentage of layout area is used by interconnect routing between cells, it has been found that the majority of bridge defects occur between the output signals of logic gates.

A bridge defect between two gate outputs appears dormant as long as the gates are driving the same logic value. However, when the two gates attempt to adopt different logic values, logic contention occurs. Depending on factors such as the drive strength of the two gates, their individual input patterns, and the characteristics of the bridge defect, the bridged node may adopt either logic value or settle at some intermediate voltage level. Also, in many cases, the bridge defect can have a significant impact on the propagation time of the bridged signals. This is particularly problematic when large parasitic delays are introduced due to the defect.

Bridge defects also cause less obvious effects that can introduce further complications. If a bridge defect creates a feedback loop, a formerly stable combinational circuit may take on oscillatory or sequential properties. Also, when an intermediate voltage level occurs, downstream logic gates with varying input voltage thresholds can interpret the same voltage level differently. This is known as the “Byzantine General's Problem”.

Bridge defects exist at various levels of severity, depending on the electrical resistance of the short circuit caused by the defect. Due to the progressive nature of wearout mechanisms that can cause bridge defects; they often start at high resistance levels and continue to become more severe as time passes. For tractability, the range of bridge resistances is often divided into two groups, hard and soft. If the resistance is relatively low, a hard defect is said to have occurred and a logical fault may be introduced into the circuit. Conversely, a higher resistance bridge causes a soft defect with performance degradation effects such as delay faults. The actual resistance value that determines the distinction between hard and soft defects varies significantly based on the process technology.

There have been numerous models developed to simulate the effects of bridge defects. Traditional bridge modelings assumed that two conflicting bridged signals were resolved by the logical AND function or the logical OR function; depending on whether positive or negative logic was used in the circuit. Using this wired-logic model to simulate the effects of interconnect shorts, an AND or OR gate could be inserted into the circuit between the two nodes. However, recent work has shown that this model is not accurate with respect to CMOS technologies. It is true, though, that the AND or OR function between bridged signals is possible, but only when there is a significant strength disparity between the pull-up and pull-down networks driving the conflicting signals. Otherwise, this model will not determine the correct logic value for the bridged node. Furthermore, it is incapable of representing the intermediate voltages and timing degradations that result from bridge defects in CMOS technologies.

In another bridge defect modeling/simulation method, switch-level simulators were used as permanent conducting transistors at the defect site. This method allows some degree of flexibility in modeling the electrical characteristics of the bridge by allowing for different sizes of the bridge defect transistor. It is more accurate than the permanent wired-logic model, but also has some limitations. For instance, inherently non-linear transistors are treated as linear resistance elements. Also, timing degradation characteristics and intermediate voltages due to the defects cannot be modeled using this approach. This can cause the Byzantine General's Problem to appear as well as produce an excessive and pessimistic number of unknown states for the bridged nodes. Finally, due to the added complexity of switch-level circuit netlists, these simulators are slow compared to gate-level simulators.

A bridge model that computes the node value at the defect site as a Boolean function of the inputs driving the bridged wires has also been proposed. One such model, the voting model, determines the node value based on the number, type, size, and state of the transistors that are driving the bridged signals. This model employs the AND/OR resolution functions only in cases where the pull-down/pull-up networks driving the shorted nodes always overpower the opposite network of the other driving cell. Similarly, it allows for a dominant driver function that always forces the bridged node to the value of the stronger gate, when such a condition exists.

However, when neither of these scenarios is known to exist, the driving gate inputs and a series of look-up tables determine the dominant network. The look-up tables are specific to a given cell library and built using data obtained from analog simulations prior to fault simulation. The tables grow linearly with the number of gates in the library. Additionally, an evolved voting model includes provisions for the Byzantine General's Problem and complex gate designs. However, this model has disadvantages in that only shorts with negligible resistance (hard shorts) can be modeled. Thus, the performance degradation effects of soft shorts, such as increased propagation delay, can not be handled. Furthermore, the capacitive loading and resistance contributed by the interconnect is not considered.

A similar model, a primitive bridge function (PBF), creates a general fault block that replaces the gates driving the bridged node as well as several downstream gates. The PBF performs a mapping from the inputs of the driving gates to the outputs of the driven gates. The PBF mapping can be determined using a variety of different approaches. For instance, known (or assumed) driving strength characteristics, such as the wired-AND model, can be directly implemented by the PBF. However, more accurately, the PBF can be derived from analog circuit simulation of the bridge defect and surrounding circuit components. This approach can take into account critical parameters of the transistors driving the bridged node as well as the varying logic thresholds of downstream gates; thereby eliminating the Byzantine General's Problem. Also, during the analog simulation phase, any electrical resistance can be set for the bridge defect, thus allowing hard and soft defects to be modeled. A disadvantage of this approach is that the number of cell combinations grows exponentially as new cells are added to the library, potentially requiring huge setup and simulation time requirements to derive the PBFs.

Mixed-mode simulators, capable of both analog and digital simulation on different portions of a circuit, have also been investigated for modeling bridge defects. Using this approach, switch or gate-level simulation is conducted throughout most of the circuit, except in the region immediately surrounding the bridge defect. In this region, the simulator switches to the analog domain, where the electrical parameters of nearby transistors and the exact bridging resistance are considered. Despite significant time-savings over full analog simulation, which is accurate but impractical, mixed-mode bridge fault simulation is still quite time consuming compared to other methods. This is due to the redundant analog simulations that would inevitably be performed on identical groups of circuit components.

Another bridge fault modeling scheme, referred to as table-based simulation, attempts to overcome the speed limitations of mixed-mode simulators with negligible loss of accuracy. In table based methods, much like the mixed-mode models, gate-level simulation is conducted throughout the circuit, except in the region around the bridge defect. At the node where two gate outputs are shorted, a table look-up is performed using the input logic values for the bridged gates to obtain an analog value for the node voltage. This is similar to the PBF model. Then, the analog node voltage is compared to logic thresholds of each gate driven by the bridged node to determine that gate's logic interpretation. The tables containing the bridge node voltage and the cell logic thresholds are built using analog simulation data. This modeling scheme has the advantages of fast execution speed and limited expense associated with deriving the look-up tables only once in the lifetime of a cell library. However, the implementations proposed do not include allowances for propagation delay increases due to the defects. This feature could possibly be implemented through the use of separate look-up tables for signal propagation times. However, they would have to be quite large to cover various input pattern changes and load conditions. Furthermore, setup and simulation time to derive the delay tables would be huge.

Another bridge modelling method uses fuzzy logic processing to compute the effects of bridge defects on a circuit. This approach begins by determining the voltage transfer characteristics for each cell in a given library using analog simulation and building a fuzzy model of the results. Then, a resistive bridge defect is inserted into the test circuit and the voltage of the bridged nodes is computed using voltage division. If the voltage of the bridged nodes is in an intermediate range, it propagates through the subsequent gates using the fuzzy models until the voltage is within normal levels. The initial voltage computation of the bridged nodes, upon which subsequent calculations are based, has insufficient accuracy. Furthermore, modeling of delay effects of bridges and interconnect parasitics are not actively considered.

### SUMMARY OF THE INVENTION

In accordance with an aspect of the present invention there is provided an apparatus for modeling and simulating the effects of bridge defects in integrated circuits, the apparatus comprising: a first logic cell for responding to first logic input fed thereto and providing first logic output; a second logic cell for responding to second logic input fed thereto and providing second logic output; and bridge defect simulation means for modeling and simulating bridge defects, the bridge defect simulation means defining an output response based on input pattern sequences in response to a defect control signal, the input pattern sequences including: the first and second logic inputs fed to the first and second logic cells, respectively; and the first and second logic outputs, the output response of the bridge defect simulation means being determined in accordance with a time of execution of the bridge defect simulation.

In accordance with another aspect of the present invention there is provided a method for modeling and simulating the effects of bridge defects in integrated circuits, the method comprising: providing a first logic cell that responds to first logic input fed thereto and provides first logic output; providing a second logic cell that responds to second logic input fed thereto and provides second logic output; and defining output response based on input pattern sequences in response to a defect control signal, the input pattern sequences including: the first and second logic inputs fed to the first and second logic cells, respectively; and the first and second logic outputs, the output response being determined in accordance with the time of execution of the bridge defect simulation.

In accordance with another aspect of the present invention there is provided A computer program product comprising a computer readable medium having computer logic stored therein for modeling and simulating the effects of bridge defects in integrated circuits, the computer program product including: a first logic cell for responding to first logic input fed thereto and providing first logic output; second logic cell for responding to second logic input fed thereto and providing second logic output; and a bridge defect simulator for modeling and simulating bridge defects, the bridge defect simulator defining its output response based on input pattern sequences in response to a defect control signal, the input pattern sequences including: the first and second logic inputs fed to the first and second logic cells, respectively; and the first and second logic outputs, the output response of the bridge defect simulator being determined in accordance with the time of execution of the bridge defect simulation.

In accordance with an exemplary aspect of the present invention, there is provided a method for simulating the effects of bridge defects generally comprising the use of a commercial VHDL simulation tool. The process involves insertion of the bridge model on interconnect wires between logic cell models along with additional simulation elements to control the injection of the defect. Then, the actual simulation is conducted and circuit outputs are written to a file. Finally, the output files are parsed and the effects of the bridge defects can be analyzed in terms of observable circuit errors.

In another exemplary aspect of the present invention, there is provided a defect-to-fault translation (D2F) tool for automating the translation step within bridge defect simulation process. In this case, the D2F software tool enables the defect-to-fault step to be automated. More specifically, the D2F automatically builds the defect circuit, determines appropriate input stimulus, conducts simulation of hard and soft bridge defects, analyses the simulation results, and generates the defect-injectable VHDL (very high speed integrated circuit description language) model.

The apparatus and method for simulating the effects of bridge defects in ICs according to an exemplary embodiment of the present invention include a neural network. The apparatus includes a multilayer feedforward neural network (MLFN), implemented within the framework of a very high speed integrated circuit hardware description language (VHDL) saboteur. The apparatus computes exact bridged node voltages and propagation delay times with due attention to surrounding circuit elements.

### BRIEF DESCRIPTION OF THE DRAWINGS

Examples of the present invention will now be described in relating to the accompanied drawings in which:

FIG. 1 illustrates a prior art saboteur fault arrangement;

FIG. 2 illustrates a saboteur fault arrangement according to an embodiment of the present invention;

FIG. 3 illustrates the bridging fault device according to an embodiment of the present invention;

FIG. 4 illustrates a flowchart of the bridging fault device shown in FIG. 3;

FIG. 5 illustrates a neural network architecture according to an embodiment of the present invention;

FIGS. 6A and 6B illustrate drive strength test circuits;

FIG. 7 is a circuit diagram illustrating an example of the voltage-level interpreter component of an embodiment according to the present invention;

FIG. 8 is a graph showing the effect of training on errors; and

FIG. 9 is a flow chart depicting the bridge simulation process according to an exemplary embodiment of the present invention.

### DETAILED DESCRIPTION

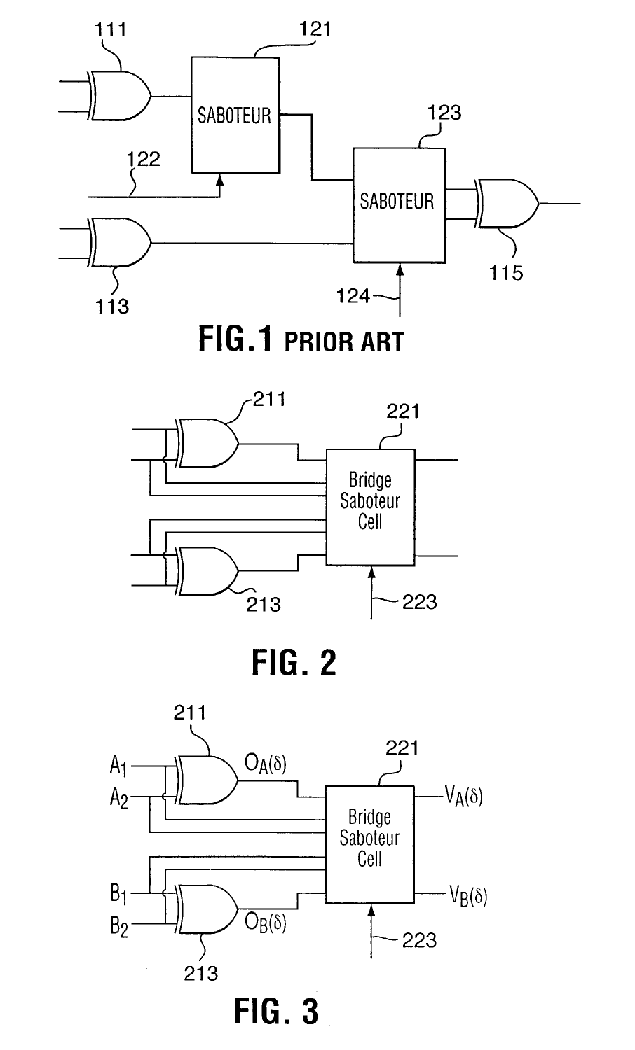

By way of background, fault modeling with very high speed integrated circuit hardware description language (VHDL) is evolving. A popular technique for VHDL fault modeling is based on the usage of a saboteur, which is a controllable component that is physically added to the VHDL netlist of a design. The saboteur is placed on nets between existing components (for example, logic circuits of an exclusive OR (XOR) gate 111 and OR gates 113 and 115) as shown in FIG. 1 and can be used to model a wide variety of fault cases. For instance, a first saboteur 121 could cause the output of the XOR gate 111 to appear as a stuck-at fault to subsequent circuit elements. Alternatively, by changing the defect control signal 122, additional delays or reduced voltage swings could be modeled. The saboteur can also be used to model or simulate bridge defects as demonstrated by a second saboteur 123 which receives a defect control signal 124. The saboteur component is implemented using a behavioral VHDL description that completely defines its output response based on the defect control state and input pattern sequence.

Prior art bridge fault models, which may include saboteurs, are unable to simulate the effects of bridging faults that are input pattern dependent or to determine the drive strength of the signal.

To alleviate such problems the saboteur design of an embodiment of the present invention includes additional signal lines to enable the saboteur to determine the circuit behavior based on the inputs of the cells driving the bridged nodes as shown in FIG. 2.

In FIG. 2, an output of an XOR gate 211 and an output of an OR gate 213 are fed to a single and modified bridge saboteur cell 221 and two inputs of the XOR gate 211 and two inputs of the OR gate 213 are also fed to the bridge saboteur cell 221 that receives a defect control signal 223.

Generally, neural networks are used for tasks such as classification, time-series prediction, noise reduction, and general function mapping in a wide variety of different scientific applications as is well known in the art. The neural network used for an embodiment of the present invention is the multilayer feedforward neural network (MLFN), or back propagation network. One advantage of the MLFN is its high performance as a function approximator. It is often referred to as a universal function approximator.

For example, given an appropriate network architecture and sufficient training, the MLFN can learn any deterministic function to an arbitrary degree of accuracy. Since the voltage and timing characteristics of electronic circuits are deterministic functions by nature, the MLFN can learn them, assuming the other conditions are met. To conduct training, the input vectors in the training set are presented to the network individually and the network's outputs are compared to the output vector that it is supposed to produce. During this process, a cumulative measure of error is computed for the training set. Then, the weights are updated, using an optimization algorithm, to reduce the measure of error for the network. Training is conducted for many passes through the training set until the network reaches a suitable level of accuracy. Although this can be a time-consuming process, using relatively fast algorithms for weight optimization in MLFNs can make it manageable.

In an embodiment of the present invention, a conjugate gradient algorithm is used for training. Therefore, an embodiment of the present invention includes a bridge fault model and method that use a neural network, within the framework of a VHDL saboteur. A single saboteur cell is developed to model bridge faults between the different components in a cell library. Instance-specific information, such as cell drive strength and propagation delay, is provided to the saboteur through generic parameters in the VHDL entity. Furthermore, the defect resistance (hard, soft, or no-defect) is controlled by the defect control signal 223. When there is no active defect, the saboteur fault model is executed in response to a transition on the nodes that it is capable of bridging. However, since there is no defect, it simply passes the logic signals in zero simulation time.

FIG. 3 shows the bridging fault device according to an embodiment of the present invention that is connected to logic cells, i.e., logic gates 211 and 213. An output of the XOR gate 211 and an output of the OR gate 213 are fed to the bridge saboteur cell 221 and two inputs A₁, A₂ of the XOR gate 211 and two inputs B1, B2 of the OR gate 213 are also fed to the bridge saboteur cell 221 which receives the defect control signal 223.

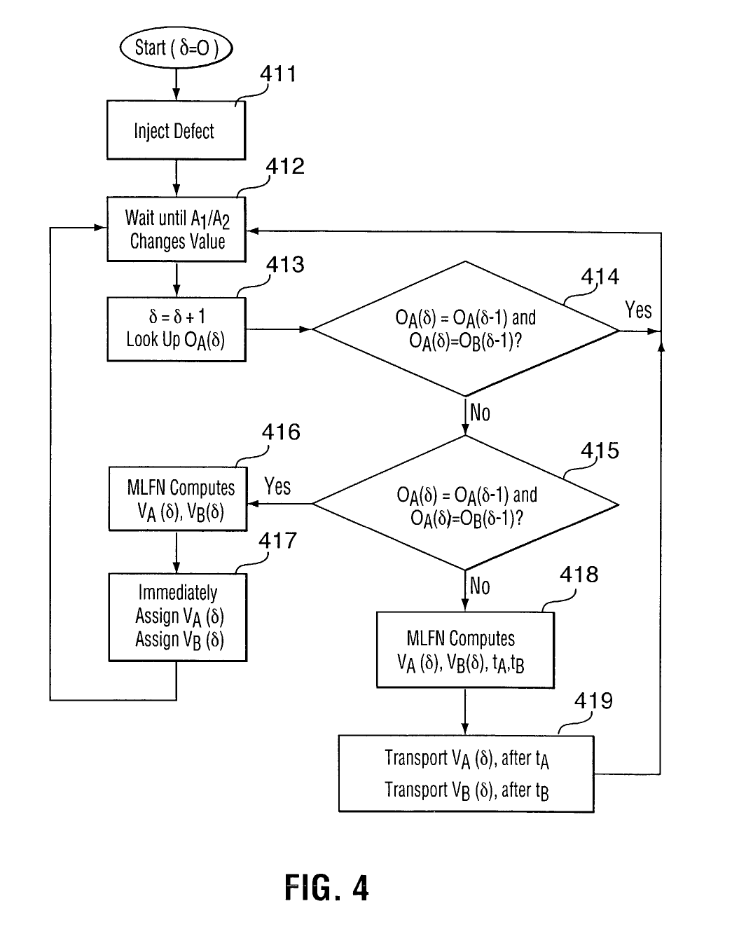

When the defect control signal 223 is set to an active defect state, the bridge model is executed in response to a transition on one of the input signals to those cells driving the bridged nodes. The flowchart of FIG. 4 details the operation of the defect-injected saboteur cell in response to a logic transition on inputs A₁ and/or A₂. The bridge fault model executes in zero simulation time and is typically invoked in response to a single event on one of its inputs.

For example, if an event on A₁ and/or A₂ occurs, the input nodes labeled B1 and B2 are usually inactive and will remain that way for at least as long as the fault model takes to execute. An equivalent flowchart can be constructed for transitions occurring on B1 and/or B2, with A₁ and A₂ inactive.

Referring to FIGS. 3 and 4, the outputs O_{A} and O_{B} of the XOR gate 211 and the OR gate 213 are the normal driven logic values (i.e., no defect). Since the bridge saboteur cell 221 determines the cell outputs, O_{A} and O_{B}, immediately after a change in the driving cell inputs (i.e., the inputs A₁, A₂ and B₁, B₂), it needs to know specific information with respect to the logic function of these cells. This information is passed to the bridge saboteur cell 221 through generic parameters during the instantiation of the bridge saboteur cell 221. The outputs of the bridge saboteur cell 221 are analog voltage values V_{A}, V_{B}. Details of how this is used to resolve the Byzantine General's problem is provided below. Finally, the model flags bridge defects as being I_{DDQ} detectable when the bridged nodes are driven to opposite logic values, allowing a direct path for current to flow from power supply to ground. The symbol “δ” in FIG. 4 represents a unit time step that increments each time the bridge model is executed.

In response to the defect control signal 223, the execution of the bridge saboteur cell 223 is initiated (a unit time δ=0). Defect is injected (step 411) and thereafter, it waits for a logic status (or voltage) change to or a transition on the XOR's input A1 and/or A2 (step 412). After sensing a transition on the XOR's input A₁ and/or A₂, the time step increments and the bridge saboteur cell 221 determines the new value for the XOR's output O_{A}(δ) (step 413). It then compares the XOR's output O_{A}(δ) to O_{A}(δ-1) and O_{B}(δ-1) (step 414) to determine how to compute the next state.

If the XOR's output O_{A} does not change value and it is equal to O_{B}(the positive determination at step 414), no action is required and returns to step 412. If the XOR's output O_{A} is different from either or both of O_{A}(δ-1) and O_{B}(δ-1) (the negative determination at step 414), new node voltages are computed because the relative drive strength of the cells may be different. If the XOR's output O_{A} remains the same but is different from O_{B}(the positive determination at step 415), the neural network will be used to compute new node voltages V_{A}(δ) and V_{B}(δ) (step 416).

The newly computed node voltages V_{A}(δ) and V_{B}(δ) are assigned immediately (step 417), because, in reality, the actual propagation time between the two intermediate voltage states would be minimal, and thereafter it returns to step 412. If the XOR's output O_{A} changes value or it is equal to O_{B} (the negative determination at step 415), the neural network will be used to compute new node voltages V_{A}(δ), V_{B}(δ) and propagation delay times t_{A} and t_{B} (step 418). Then, the newly computed node voltages V_{A}(δ) and V_{B}(δ) are assigned after the expiration of the computed propagation delay times t_{A} and t_{B} (step 419) and it returns to step 412.

To resolve timing issues, VHDL's transport delay mechanism is used.

Specifically, if a transition is to occur after all other scheduled events, then it 30 simply occurs at that time, after the other events. However, if the transition is supposed to occur before other scheduled events, then it pre-empts these events. In the rare case when the A inputs change at the exact same time as the B inputs, the bridge saboteur cell 221 immediately looks up the new logic values and propagation delay times for both nodes. If the new logic values are the same, full swing voltage levels for V_{A} and V_{B} are assigned immediately after the smaller of the two propagation delay times. Otherwise, the voltage changes are computed and assigned in the order that O_{A} and O_{B} would change states in the defect free situation. This approach ensures that the final voltage is correct and provides a reasonable timing approximation as the node voltages switch through the various states.

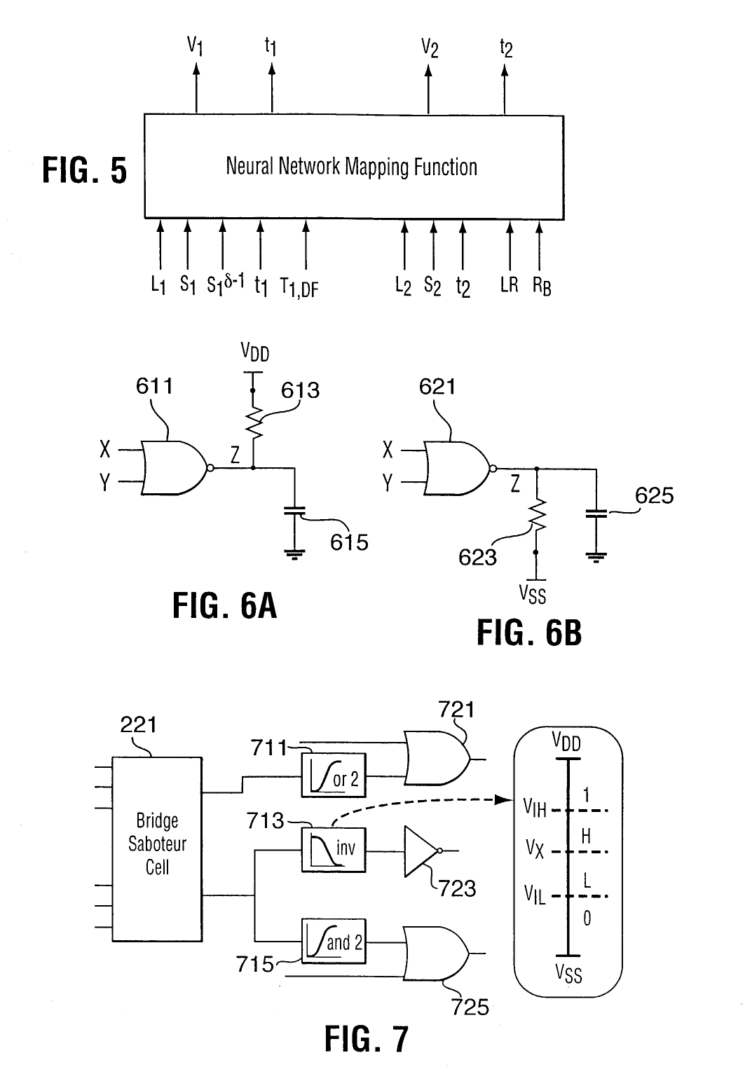

Turning to FIG. 5, a diagram of a neural network architecture for the bridge fault device according to an embodiment of the present invention is provided. The output variables define the voltage, V, and a delay factor, t, of the two bridged nodes with respect to the input variables. These values are computed in response to an appropriate change on the inputs to the preceding cells as described in FIGS. 3 and 4. As a convention, the node driven by the active cell is node 1, or the active node. Conversely, the other node is referred to as node 2, or the inactive node.

The input vector for the neural network has 10 specific elements. The inputs L₁ and L₂ are the defect-free logic values driven by the active and inactive cells, respectively. Elements S₁ and S₂ are input-pattern dependent measures of relative drive strength for the two cells. The electrical resistance of the bridge defect is R_{B}. Both the final voltage and the propagation delay of the bridged nodes depend on these values. However, the propagation delay computations depend on several additional parameters. The values t₁ and t₂ are input-pattern dependent charge times for each cell driving one standard load. These parameters contribute information about the capacitive characteristics of the pull-up/pull-down network within each cell. The parameter, S₁^{δ-1}, is the drive strength of the active cell prior to the transition. This provides an indication of the bridge node voltages before the transition, allowing a better estimate of the transition time to the next state.

The parameter, T_{1,DF}, is the defect-free propagation time of the current logic transition on the active cell. It is determined from the timing information in a Standard Delay Format (SDF) file known in the art. Since this data is back annotated from various tools in ASIC design flow, it infers the most accurate loading factors available. Furthermore, provision of an SDF timing file allows the entire VHDL circuit simulation to implement a various timing algorithms known in the art.

The neural network outputs, T_{1,DF} are also used as a time base multiplier for the delay factors output by the network. For instance, if T_{1,DF} is equal to 200 picoseconds and the delay factor, t₁, is computed by the neural network as 2.0, then the propagation delay for bridged node is modeled as 400 picoseconds. The last parameter, LR, is referred to as the load ratio and is simply a ratio of the fanout for the active cell to the fanout of the inactive cell. This provides the network with a concise estimate of the actual load on the node driven by the inactive cell.

The drive strength variables, S₁ and S₂, are determined using test circuits shown in FIGS. 6A and 6B. In the circuit shown in FIG. 6A, a NOR gate 611 (or a cell) has two logic inputs X and Y and an output Z. The output terminal of the NOR gate 611 is connected to a voltage terminal of voltage VDD (ideal +3.3 volts) via a resistor 613 having a resistance of 1 KΩ and to the ground via a capacitor 615.

| X | Y | Z (Voltage) |
|---|---|---|
| 0 | 1 | 1.1079 |
| 1 | 0 | 1.1079 |
| 1 | 1 | 0.5662 |

Similarly, in the circuit shown in FIG. 6B, a NOR gate 621 (or a cell) has two logic inputs X and Y and an output Z. The output terminal of the NOR gate 621 is connected to another voltage terminal of voltage V_{SS} (ideal 0 volts) via a resistor having a resistance of 1 KΩ and to the ground via a capacitor 625.

| X | Y | Z (Voltage) |
|---|---|---|
| 0 | 0 | 0.7260 |

The resistance value (1 KΩ) of the resistors 615 and 625 is selected somewhat arbitrarily, but its actual value is insignificant as long as it remains constant for all cells tested. Then, for every input pattern driving the logic value opposite to the external source, the node voltage at the output of the cell is measured as the drive strength. It can be seen that (FIGS. 6A and 6B) different input patterns that cause the same logic response do indeed have different drive capabilities.

The charge time parameters, t₁ and t₂, are collected in a similar manner. Specifically, individual defect-free cells are loaded with a capacitance equivalent to one standard load. Then, for each input pattern combination, the charge/discharge time at the output node is determined. Again, since the arbitrary load circuit is kept constant across all tests, a suitable relative measure of charge time will be obtained.

The Byzantine General's problem occurs when the bridged lines adopt an intermediate voltage level, with downstream cells interpreting this voltage at different logic values. By using voltage-level interpreter components, which are specifically derived for each input of each cell in the library, the bridge fault device has an effective mechanism to mitigate this problem.

Referring to FIG. 7, which shows a voltage-level interpreter components, the voltage-level interpreters 711, 713 and 715 are placed immediately preceding the respective cells (an OR gate 721, an inverter 723 and an AND gate 725) on a bridged node, along the bridge saboteur cell 221. When a voltage change is sensed by a respective one of the voltage-level interpreters 711, 713 and 715, it compares the voltage change to the voltage transfer characteristics for the respective one of the downstream cells (i.e., the OR gate 721, the inverter 723 and the AND gated 725) and determines an appropriate logic value.

Specifically, with reference to the voltage-level interpreter 713 for the inverter 723, the lowest input voltage interpreted as logic high, V_{IH}, the highest input voltage interpreted as logic low, V_{IL}, and the switching voltage, V_{X}, are used to determine the logic values as shown in FIG. 7. Depending on the application of the fault model, it may be prudent to interpret the ‘H’ and ‘L’ logic values as ‘X’ to account for process variations, noise, and environmental factors.

Training and validation of the neural network for the bridge fault model requires data from several sample bridge defects for a given cell library. An example cell library based on TSMC's 0.35μ, 3 metal layer, CMOS technology is available from the Canadian Microelectronics Corporation. It contains several dozen combinational logic cells and a wide variety of latches and D flip-flops, including scannable cells. Bridge defect data is derived using analog simulation and covers a broad range of possible bridge defect scenarios.

For instance, bridge defects between cells of varying drive strength combinations are included in the training set to ensure that the network can “learn” the effects of cell drive strength on the circuit behavior. Furthermore, a wide range of loading conditions and both soft and hard bridge defect resistances are considered. Finally, for each of the combinations possible from these variables, various logic and drive strength transitions are included. Given the large number of cases possible from these conditions, time is spent deriving the training data before the bridge fault model can be completed.

To reduce the time required to derive the training data, a defect-to-fault (D2F) translation is included in the bridging fault system according to an embodiment of the present invention. The D2F tool is a program that can be implemented using the Tcl scripting language and the Tk Toolkit for example. To conduct the bridge defect simulations, a user selects a cell from the cell library and specifies a load circuit. Then, another cell in the library is selected along with its load circuit. The D2F tool builds the defect circuit, determines appropriate input stimulus, and conducts simulation of hard and soft bridge defects.

The simulation results are analyzed by the tool and output voltage and propagation delay data is written to a file. The D2F tool is capable of performing bridge defect analysis using various simulation device models supported by the analog simulation engine. All simulations conducted for the sample cell library were performed using BSIM3v3.1 device models at 3.3 Volts supply and typical process/temperature parameters. The procedure would be similar for data collected at worst/best case voltage/process/temperature parameters.

Furthermore, two different defect severity levels were studied for the sample cell library. Hard and soft defects were studied at bridge resistances of 750Ω and 3000Ω, respectively. These values are within the ranges accepted in the art, and were precisely selected for the example of the present invention based on results of analog simulation. Using a greater number of different resistances would result in a more flexible neural network, at the cost of more time to derive the training set and conduct the training.

Training of the neural network is conducted using a random subset of the bridge defect data samples derived using the D2F tool. The remaining samples are used for testing and validating the neural network.

The rationale behind this approach is that the neural network should certainly be capable of leaming its training set, assuming that the architecture is appropriate and the learned function is deterministic. In this case, the true measure of performance may be assessed when it is tested using a set of data that it has not yet been exposed to. Furthermore, as the performance of particular network is continually evaluated using the separate test data set, architecture and training decisions eventually become influenced by the particular characteristics of this set as well.

To summarize, the set of derived bridge defect data is separated into three sets. These sets are referred to as the training set, the test set, and the validation set. For the sample cell library, data was collected for 130 of the several thousand possible bridge defects; with 70 arbitrarily allocated to the training set and the remaining 60 divided between the test and validation sets. Before training commences, the input and output data for the neural network is scaled for uniformity and to ensure that it is within acceptable ranges.

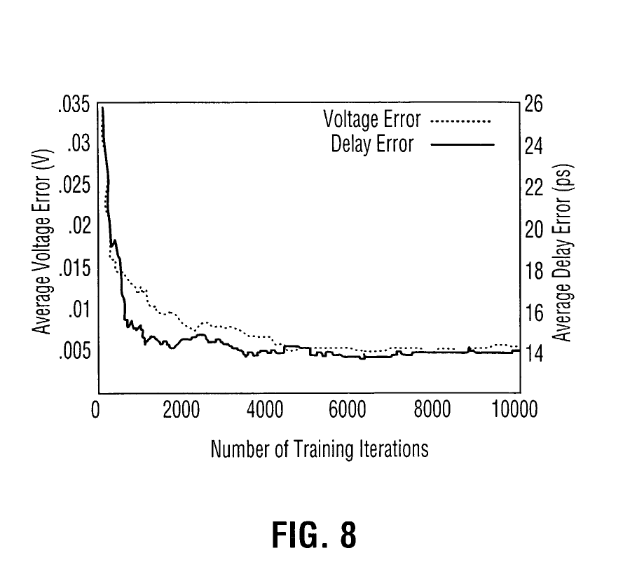

Training of the bridge fault model for the sample cell library was conducted for 10000 iterations. The voltage and delay error were evaluated every 100 iterations. FIG. 8 shows the performance of the neural network, evaluated using the test set, at 100 iteration intervals throughout the training. The node voltage line shows the average voltage deviation, from the analog simulation results, of both bridged nodes across all input pattern combinations for the 30 defects in the test set. Similarly, the delay time curve shows the average delay error, compared to analog simulation, of both bridged nodes across all input patterns for the 30 defects in the test set. The rate of training for this network, with the 70 defect training set, is approximately 1800 iterations/hour on a given computing environment Training is a one time process and, therefore, is not a significant issue for deriving the model.

The results presented in FIG. 8 show that training significantly reduces the test set prediction error until around 6000 iterations (200 minutes). Subsequent training, which continues to reduce the mean square error for the training set, shows mixed performance benefits for the test set. During the training beyond 6000 iterations, the neural network is learning irrelevant details about the training set with respect to the general bridge defect population, which can negatively affect performance for samples not in the training set. Increasing the size and diversity of the training set would provide further accuracy for test set predictions. Nonetheless, FIG. 8 indicates that the existing network predicts the node voltages surrounding bridge defects. Furthermore, achieving an average delay prediction error below 14 picoseconds, the neural network produces respectable results in a domain where no other model, short of full analog simulation, has even made an attempt in the past.

Considering that the gate loading parameters are typically only an estimate at this point, and there are significant timing variations due to process and environmental conditions. To confirm the accuracy of the neural network, the validation set is used. Inspection of FIG. 8 suggests that the network is optimally trained somewhere between 6000 and 7000 training iterations. The trained weight states are arbitrarily extracted at 6600 iterations for subsequent validation experiments.

Testing the 30 bridge defects in the validation set, after 6,600 iterations of training, the average voltage error was found to be 0.0059 volts and the average delay error was 14.15 picoseconds. These figures are in the same range as those found using the test set. As yet another confirmation of the neural network's accuracy, 20 more bridge defects were selected randomly from the list of cells by an independent 3rd party. The actual defect behavior was then derived using the D2F Tool for comparison with the neural network predictions. Results show that the average voltage error for this set is 0.0071 volts and the average delay error is 12.14 picoseconds, both of which are within the same range as the previous error computations. Since the neural network had no prior exposure to the randomly selected bridge defects in either of these validation sets, it can be concluded with reasonable assurance that the network is adequately trained for this cell library.

After the neural network has been trained and validated, the D2F tool automatically generates the defect-injectable VHDL saboteur cell. Also, the voltage interpreter components used for resolving the Byzantine General's Problem are generated based on information collected during defect-free cell characterization. Thereafter, analysis of digital circuit designs is performed. For the latter, a specialized software tool for automating the defect injection process is used. Then, using a few benchmark circuits, various results are provided with respect to observed error response to the bridge faults.

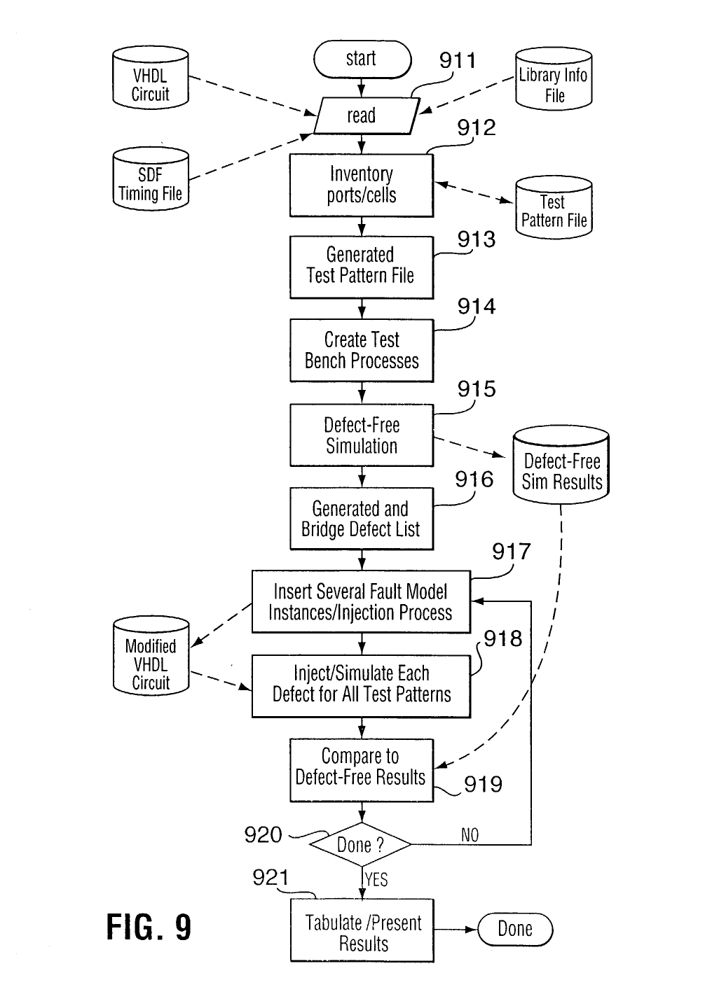

Given that moderate sized VHDL structural circuit description typically contains several thousand individual cells, the task of manually inserting bridge faults and analyzing the simulation results is difficult. Thus, a tool, written in Tcl/Tk, was used to automate these administrative tasks and invoke the commercial VHDL simulation tools. FIG. 9 outlines the operation of the bridge fault analysis tool.

The bridge simulation process starts by reading a structural VHDL circuit description and its most recent SDF timing file as written by a commercial synthesis tool (step 911). It also reads a library technology file, written by the D2F tool, which contains all of the necessary information regarding cell I/O pins, logic functions, drive strengths, charge times, and voltage transfer characteristics. Then, after conducting an inventory of the ports and cells listed in the VHDL circuit description (step 912), a test pattern file is generated (pseudorandomly) or read from a file if available (step 913). Test bench processes are then added to the structural VHDL circuit description (step 914). These processes apply the test patterns to the circuit inputs and record the outputs in ASCII result files.

A defect-free simulation is conducted at this point to enable comparison with defect-injected results (step 915). Before the bridge defect injection process can begin, a list of bridge defects is required. An option is provided to build an exhaustive set of bridge defects, a pseudorandom set of bridge defects, or to read a list of bridge defects from a file (step 916). Selecting an exhaustive list, the total number of bridge defects to consider is of O(n2), or n(n−1)/2 to be exact, where n is the number of nodes in the circuit.

Selecting a random subset of these defects is a reasonable approach to use when no layout information is available or for validating a fault modeling technique. However, since close physical proximity between nodes is generally required for bridging defects to occur, the majority of cases in the exhaustive or randomly selected subset are physically difficult.

Thus, an accurate and efficient set of bridge defects would be derived using an inductive fault analysis approach, whereby likely bridge defects are selected based on the proximity and length of circuit interconnects. The tool is capable of importing bridge defect lists from other tools known in the art. Once the bridge defect list is selected, the defect-injectable saboteurs are inserted into the VHDL netlist along with the voltage interpreter components for each connection downstream from the defect site. However, to avoid overcomplicating the circuit and bogging the simulation down with dormant bridge fault models, only a subset of VHDL saboteurs were inserted for each iteration. Each node may have only one bridge fault model attached to it. When the bridge fault model instances are inserted into the VHDL netlist, logic behavior, charge time, and drive strength tables for the driving cells are loaded into the entity through generic parameters. The gate fanouts of the two bridged cells are also passed to enable computation of the load ratio parameter. Finally, the defect-free propagation times, T_{1,DF}, for the driving cells are provided from the timing information in the SDF file.

After the bridge fault model instances are inserted into the circuit (step 917), a VHDL process is added to the circuit netlist to enable individual injection of defects into the bridge fault models (step 918). This defect injection process controls whether each bridge fault model is dormant, or is modeling a soft or hard defect. Dormant fault models will simply translate the logic values at their inputs to the correct voltage level, which will in turn be translated back to the logic domain by the voltage interpreter cells in zero simulation time.

The simulator is invoked and the first bridge defect from the list is injected into its corresponding bridge fault model. The entire set of test patterns is applied sequentially to the circuit and the observable circuit outputs are written to a file for analysis. The circuit is then reset and each subsequent defect in the list is individually injected and simulated. Following each simulator run, the output file is compared to the defect free simulation results by the defect analysis tool (step 919) and a concise summary file is created. After all of the bridge defects in the list have been simulated (the positive determination at step 920), the summary files are combined and relevant statistics are tabulated (step 921).

### EXAMPLE

### Validation of Bridging Fault Device

To test the new bridge fault model and defect injection mechanism, a few sample circuits were selected from publicly available sources. Specifically, RTL VHDL descriptions of circuits b11, b14, and b21 were synthesized using the 0.35μ cell library described previously. A sample list of characteristics of these benchmark circuits are presented in Table 1 below. For each benchmark circuit, a test pattern file with 200 test vectors was generated pseudorandomly using the bridge fault analysis tool. Then, after the defect-free simulation, bridge defect lists were randomly generated and simulations were conducted for the three circuits as detailed in Table 2 below.

All simulations were run on a Sun Ultra™ Enterprise 4500 server, utilizing 10×400 MHz UltraSPARC II™ processors. The number of bridge defects reported in the table includes an equal number of soft and hard defects. Each circuit was simulated at two different clock speeds, one with plenty of slack time and the other with virtually no slack time in the critical path. The results reported in the Soft/Hard defect coverage column are the percentage of soft and hard defects that caused logical errors at the circuit outputs

TABLE 1
Characteristics of Benchmark Circuits

| | Input | Output | |
|---|---|---|---|
| Circuit | Pins | Pins | # Cells |
| b11 | 7 | 6 | 439 |
| b14 | 32 | 54 | 4651 |
| b21 | 32 | 22 | 11224 |

TABLE 2
Benchmark Circuit Test Results

| | Clock | | # Bridge | Simulation | | Soft/Hard Defect |
|---|---|---|---|---|---|---|
| Circuit | Period | | Defects | Time | | Coverage (%) |
| b11 | 12 | ns | 10000 | 43 | minutes | 37.4/60.3 |
| b11 | 7.5 | ns | 10000 | 39 | minutes | 40.8/63.7 |
| b14 | 25 | ns | 10000 | 293 | minutes | 20.1/51.4 |
| b14 | 20 | ns | 10000 | 256 | minutes | 21.3/54.1 |
| b21 | 30 | ns | 40000 | 30 | hours | 9.7/31.5 |
| b21 | 22 | ns | 40000 | 28 | hours | 9.9/32.1 |

Results presented in the above tables show that for the benchmark circuits, faster clock speeds cause a notably higher incidence of observable faults. As a specific example, if the defect coverage data was intended for use as the cost function in a test pattern generation scheme, those defects causing delay faults only are ignored. Despite that several of them would likely be fortuitously covered by the test set, many others would go undetected due to lack of specific tests generated for them.

To provide an indication of the effects of increasing the number of test patterns and to show that these bridge defects are indeed testable, the hard defect tests were repeated for circuit b11 at a 7.5 ns clock period using test pattern files of 100, 500, and 5000 test vectors. These results are presented in Table 3 below along with the results reported previously for the 200 vector test pattern set. Increasing the number of test patterns improves the defect coverage considerably. However, as with any pseudorandom test pattern generation scheme, increasing the number of test patterns inevitably reaches a point where benefits are offset by the increased simulation time requirements. Also, we see that the simulation time scales almost proportionately with the number of test vectors.

TABLE 3
Effects of Varying the Number of Test Vectors

| Circuit & Test Set | # Bridge | Simulation | | Hard Defect |
|---|---|---|---|---|
| Size | Defects | Time | | Coverage (%) |
| b11-100 vectors | 5000 | 11 | minutes | 57.5 |
| b11-200 vectors | 5000 | 20 | minutes | 63.7 |
| b11-500 vectors | 5000 | 46 | minutes | 67.1 |
| b11-5000 vectors | 5000 | 427 | minutes | 83.5 |

Considering that the simulation engine implements the sign-off quality VITAL modeling specification, observed simulation times are certainly within reason. To demonstrate this, simulation time comparisons are conducted between the defect-free VHDL netlists and the netlists with 100 bridge fault model instances, including all associated signal and interpreter cell overhead. The circuits with the fault models were simulated using the 200 vector test pattern set, individually injecting both soft and hard defects into each fault model. The defect free circuits were simulated for an equivalent number of clock cycles. Simulation time results from these tests are reported in Table 4 below. For these circuits, the added overhead and calculations required to implement the fault model induce a reasonably small simulation time penalty beyond the industry standard VITAL specification.

TABLE 4
Simulation Time for Defect-Injected and Defect-Free Circuits

| | Defect- | Defect- | |
|---|---|---|---|
| Circuit | Free | Injected | % Increase |
| b11 | 03:01 | 03:42 | 22.65% |
| b14 | 28:53 | 33:59 | 17.66% |
| b22 | 54:45 | 57:30 | 5.02% |

In the embodiment of the present invention, a VHDL is used as a suitable mechanism for implementing the neural network. Other suitable mechanisms that can be used to implement the model include other HDLs (Verilog), or creating a custom simulation software tool.

Embodiments of the present invention may be implemented in any conventional computer programming language. For example, embodiments may be implemented in a procedural programming language (e.g. “C”) or an object oriented language (e.g. “C++”). Further embodiments of the invention may be implemented as pre-programmed hardware elements, other related components, or as a combination of hardware and software components.

Embodiments can be implemented as a computer program product for use with a computer system. Such implementation may include a series of computer instructions fixed either on a tangible medium, such as a computer readable medium (e.g. a diskette, CD-ROM, ROM, or fixed disk) or transmittable to a computer system, via a modem or other interface device, such as a communications adapter connected to a network over a medium, The medium may be either a tangible medium (e.g. optical or electrical communications lines) or a medium implemented with wireless techniques (e.g. microwave, infrared or other transmission techniques). The series of computer instructions embodies all or part of the functionality previously described herein. Those skilled in the art should appreciate that such computer instructions can be written in a number of programming languages for use with many computer architectures or operating systems.

Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g. shrink wrapped software), preloaded with a computer system (e.g., on system ROM or fixed disk), or distributed from a server over the network (e.g., the Internet or World Wide Web). Some embodiments of the invention may be implemented as a combination of both software (e.g. a computer program product) and hardware (termed mechanisms). Still other embodiments of the invention may be implemented as entirely hardware, or entirely software (e.g. a computer program product).”

Although particular embodiments of the present invention have been described in detail, there are numerous variations. It should be appreciated that numerous variations, modifications, and adaptations may be made without departing from the scope of the present invention as defined in the claims.

What is claimed is:

1. An apparatus for modeling and simulating the effects of bridge defects in integrated circuits (ICs), the apparatus comprising:
a first logic cell for responding to first logic input (A₁, A₂) fed thereto and providing first logic output (O_{A});
a second logic cell for responding to second logic input (B₁, B₂) fed thereto and providing second logic output (O_{B}); and
bridge defect simulation means for modeling and simulating bridge defects, the bridge defect simulation means defining an output response (V_{A}(δ), V_{B}(δ)) based on input pattern sequences in response to a defect control signal, the input pattern sequences including:
the first and second logic inputs (A₁, A₂; B₁, B₂) fed to the first and second logic cells, respectively; and
the first and second logic outputs (O_{A}, O_{B}),
the output response (V_{A}(δ), V_{B}(δ)) of the bridge defect simulation means being determined in accordance with a time (δ) of execution of the bridge defect simulation.

2. The apparatus of claim 1, wherein the bridge defect simulation means includes determination means for determining the status of the first and second logic outputs (O_{A}, O_{B}) provided from the first and second logic cells in accordance with the simulation execution time (δ), the simulation execution time (δ) being incremented.

3. The apparatus of claim 2, wherein the bridge defect simulation means includes output means for providing response output (V_{A}(δ), V_{B}(δ); t_{A}, t_{B}) resulting from the execution of the bridge defect simulation.

4. The apparatus of claim 3, wherein the first and second logic cells include logic circuit gates, the logic status of the first and second logic inputs (A₁, A₂; B₁, B₂) and the logic status of the first and second logic outputs (O_{A}, O_{B}) being represented by voltage.

5. The apparatus of claim 4, wherein the bridge defect simulation means includes means for sensing a transition on the voltage representing the first and second logic inputs (A₁, A₂).

6. The apparatus of claim 5, wherein the determination means determines the status of the first logic output (O_{A}(δ)) in response to the sensed transition on the voltage representing the first logic input (A₁).

7. The apparatus of claim 6, wherein the output means includes providing means for providing the response output (V_{A}(δ), V_{B}(δ); t_{A}, t_{B}) in response to the status of the first and second logic outputs (O_{A}(δ), O_{B}(δ), O_{A}(δ-1), O_{B}(δ-1)) determined in the simulation execution time (δ) and a previous simulation execution time (δ-1).

8. The apparatus of claim 7, wherein the providing means includes:
first output determination means for determining whether the status of the first logic output (O_{A}(δ)) in the simulation execution time (δ) is the same as the status of the first logic output (O_{A}(δ-1)) in the previous simulation execution time (δ-1); and
second output determination means for determining whether the status of the first logic output (O_{A}(δ)) in the simulation execution time (δ) is the same as the status of the second logic output (O_{B}(δ-1)) in the previous simulation execution time (δ-1), wherein the providing means providing the response output (V_{A}(δ), V_{B}(δ); t_{A}, t_{B}) in response to the determination results provided by the first and second output determination means.

9. The apparatus of claim 8, wherein the providing means includes computing means having:
means for determining response output voltages (V_{A}(δ), V_{B}(δ)) corresponding to the first and second logic outputs (O_{A}, O_{B}) in a case of (i) the status of the first logic output (O_{A}(δ)) in the given simulation execution time (δ) being the same as the status of the first logic output (O_{A}(δ-1)) in the previous simulation execution time (δ-1); and (ii) the status of the first logic output (O_{A}(δ)) in the simulation execution time (δ) differing from the status of the second logic output (O_{B}(δ-1)) in the previous simulation execution time (δ-1); and
means for determining response output voltages (V_{A}(δ), V_{B}(δ)) and propagation delay times (t_{A}, t_{B}) corresponding to the first and second logic outputs (O_{A}, O_{B}) in a case of the status of the first logic output (O_{A}(δ)) in the given simulation execution time (δ) differing from the status of the first logic output (O_{A}(δ-1)) in the previous simulation execution time (δ-1).

10. The apparatus of claim 9, wherein the computing means is provided by a neural network, the network comprising a multilayer feedforward neural network for computing the response output voltages (V_{A}(δ), V_{B}(δ)) and propagation delay times (t_{A}, t_{B}).

11. A method for modeling and simulating the effects of bridge defects in integrated circuits (ICs), the method comprising:
providing a first logic cell that responds to first logic input (A₁, A₂) fed thereto and provides first logic output (O_{A});
providing a second logic cell that responds to second logic input (B₁, B₂) fed thereto and provides second logic output (O_{B}); and
defining output response (V_{A}(δ), V_{B}(δ)) based on input pattern sequences in response to a defect control signal, the input pattern sequences including:
the first and second logic inputs (A₁, A₂; B₁, B₂) fed to the first and second logic cells, respectively; and
the first and second logic outputs (O_{A}, O_{B}), the output response (V_{A}(δ), V_{B}(δ)) being determined in accordance with the time (δ) of execution of the bridge defect simulation.

12. The method of claim 11, wherein the step of defining includes determining the status of the first and second logic outputs (O_{A}, O_{B}) provided from the first and second logic cells in accordance with a simulation execution time (δ), the simulation execution time (δ) being incremented.

13. The method of claim 12, wherein the step of defining includes providing response output (V_{A}(δ), V_{B}(δ); t_{A}, t_{B}) as results from the execution of the bridge defect simulation.

14. The method of claim 13, wherein:
the step of providing the first logic cell includes providing a first logic gate; and
the step of providing the second cell includes providing a second logic gate, wherein the logic status of the first and second logic inputs (A₁, A₂; B₁, B₂) and the logic status of the first and second logic outputs (O_{A}, O_{B}) being represented by voltage.

15. The method of claim 14, wherein the step of defining includes sensing a transition on the voltage representing the first and second logic inputs (A₁, A₂).

16. The method of claim 15, wherein the step of sensing includes determining the status of the first logic output (O_{A}(δ)) in response to the sensed transition on the voltage representing the first logic input (A₁).

17. The method of claim 16, wherein the step of determining includes providing the response output (V_{A}(δ), V_{B}(δ); t_{A}, t_{B}) in response to the status of the first and second logic outputs (O_{A}(δ), O_{B}(δ), O_{A}(δ-1), O_{B}(δ-1)) determined in the simulation execution time (δ) and the previous simulation execution time (δ-1).

18. The method of claim 17, wherein the step of providing includes:
determining whether the status of the first logic output (O_{A}(δ)) in the simulation execution time (δ) is the same as the status of the first logic output (O_{A}(6-1)) in the previous simulation execution time (8-1); and
determining whether the status of the first logic output (O_{A}(δ)) in the simulation execution time (δ) is the same as the status of the second logic output (O_{B}(δ-1)) in the previous simulation execution time (δ-1),
the response output (V_{A}(δ), V_{B}(δ); t_{A}, t_{B}) being provided in response to the determined results.

19. The method of claim 18, wherein the step of providing further includes:
determining response output voltages (V_{A}(δ), V_{B}(δ)) corresponding to the first and second logic outputs (O_{A}, O_{B}) in a case of (i) the status of the first logic output (O_{A}(δ)) in the simulation execution time (δ) being the same as the status of the first logic output (O_{A}(δ-1)) in the previous simulation execution time (δ-1); and (ii) the status of the first logic output (O_{A}(δ)) in the simulation execution time (δ) differing from the status of the second logic output (O_{B}(δ-1)) in the previous simulation execution time (δ-1); and
determining response output voltages (V_{A}(δ), V_{B}(δ)) and propagation delay times (t_{A}, t_{B}) corresponding to the first and second logic outputs (O_{A}, O_{B}) in a case of the status of the first logic output (O_{A}(δ)) in the simulation execution time (δ) differing from the status of the first logic output (O_{A}(δ-1)) in the previous simulation execution time (δ-1).

20. The method of claim 19, wherein the computing step includes using a neural network, the neural network comprising a multilayer feedforward neural network for computing the response output voltages (V_{A}(δ), V_{B}(δ)) and propagation delay times (t_{A}, t_{B}).

21. A method for analyzing the bridge defects in integrated circuits (ICs), the method includes using the response output voltages (V_{A}(δ), V_{B}(δ)) and propagation delay times (t_{A}, t_{B}) computed by the method as defined in claim 20.

22. A computer program product comprising a computer readable medium having computer logic stored therein for modeling and simulating the effects of bridge defects in integrated circuits (ICs), the computer program product including:
a first logic cell for responding to first logic input (A₁, A₂) fed thereto and providing first logic output (O_{A});
a second logic cell for responding to second logic input (B₁, B₂) fed thereto and providing second logic output (O_{B}); and
a bridge defect simulator for modeling and simulating bridge defects, the bridge defect simulator defining its output response (V_{A}(δ), V_{B}(δ)) based on input pattern sequences in response to a defect control signal, the input pattern sequences including:
the first and second logic inputs (A₁, A₂; B₁, B₂) fed to the first and second logic cells, respectively; and
the first and second logic outputs (O_{A}, O_{B}),
the output response (V_{A}(δ), V_{B}(δ)) of the bridge defect simulator being determined in accordance with the time (δ) of execution of the bridge defect simulation.

23. The computer program product of claim 22, wherein the bridge defect simulator includes determination means for determining the status of the first and second logic outputs (O_{A}, O_{B}) provided from the first and second logic cells in accordance with the simulation execution time (δ), the simulation execution time (δ) being incremented.

24. The computer program product of claim 23, wherein the bridge defect simulator includes output means for providing response output (V_{A}(δ), V_{B}(δ); t_{A}, t_{B}) resulting from the execution of the bridge defect simulation.

25. The computer program product of claim 24, wherein the first and second logic cells include logic circuit gates, the logic status of the first and second logic inputs (A₁, A₂; B₁, B₂) and the logic status of the first and second logic outputs (O_{A}, O_{B}) being represented by voltage.

26. The computer program product of claim 25, wherein the bridge defect simulator includes means for sensing a transition on the voltage representing the first and second logic inputs (A₁, A₂).

27. The computer program product of claim 26, wherein the determination means determines the status of the first logic output (O_{A}(δ)) in response to the sensed transition on the voltage representing the first logic input (A₁).

28. The computer program product of claim 27, wherein the output means includes providing means for providing the response output (V_{A}(δ), V_{B}(δ); t_{A}, t_{B}) in response to the status of the first and second logic outputs (O_{A}(δ), O_{B}(δ), O_{A}(δ-1), O_{B}(δ-1)) determined in the simulation execution time (δ) and the previous simulation execution time (δ-1).

29. The computer program product of claim 28, wherein the providing means includes:
first output determination means for determining whether the status of the first logic output (O_{A}(δ)) in the simulation execution time (δ) is the same as the status of the first logic output (O_{A}(δ-1)) in the previous simulation execution time (δ-1); and
second output determination means for determining whether the status of the first logic output (O_{A}(δ)) in the simulation execution time (δ) is the same as the status of the second logic output (O_{B}(δ-1)) in the previous simulation execution time (δ-1), wherein the providing means provides the response output (V_{A}(δ), V_{B}(δ); t_{A}, t_{B}) in response to the determination results provided by the first and second output determination means.

30. The computer program product of claim 29, wherein the providing means includes:
means for determining response output voltages (V_{A}(δ), V_{B}(δ)) corresponding to the first and second logic outputs (O_{A}, O_{B}) in a case of (i) the status of the first logic output (O_{A}(δ)) in the simulation execution time (δ) being the same as the status of the first logic output (O_{A}(δ-1)) in the previous simulation execution time (δ-1); and (ii) the status of the first logic output (O_{A}(δ)) in the simulation execution time (δ) differing from the status of the second logic output (O_{B}(δ-1)) in the previous simulation execution time (δ-1); and
means for determining response output voltages (V_{A}(δ), V_{B}(δ)) and propagation delay times (t_{A}, t_{B}) corresponding to the first and second logic outputs (O_{A}, O_{B}) in a case of the status of the first logic output (O_{A}(δ)) in the simulation execution time (δ) differing from the status of the first logic output (O_{A}(δ-1)) in the previous simulation execution time (δ-1).

31. The computer program product of claim 30, wherein the computing means includes a neural network, the neural network having a multilayer feedforward neural network for computing the response output voltages (V_{A}(δ), V_{B}(δ)) and propagation delay times (t_{A}, t_{B}).
